(19) United States
(12) Patent Application Publication
(10) Pub. No.: US 2014/0263450 A1
(43) Pub. Date: Sep. 18, 2014

(54) FEED SYSTEM FILTERS FOR A HOT MELT SYSTEM

(71) Applicant: GRACO MINNESOTA INC., Minneapolis, MN (US)

(72) Inventors: Daniel P. Ross, Maplewood, MN (US); Paul R. Quam, Brooklyn Center, MN (US); Robert J. Lind, Robbinsdale, MN (US); Douglas B. Farrow, Plymouth, MN (US); John S. Lihwa, Willowick, OH (US); Joseph E. Tix, Hastings, MN (US); Mark J. Brudevold, Fridley, MN (US); Mark T. Weinberger, Mounds View, MN (US); Mark W. Sheahan, Inver Grove Heights, MN (US); Shaun M. Cook, Tampa, FL (US); Nicholas D. Long, Broadview Heights, OH (US); Michael J. Sebion, Apple Valley, MN (US)

(73) Assignee: GRACO MINNESOTA INC., Minneapolis, MN (US)

(21) Appl. No.: 13/796,732

(22) Filed: Mar. 12, 2013

(51) Int. Cl. B67D 7/80

(52) U.S. Cl. CPC F17D 1/084
USPC 222/146.2

(57) ABSTRACT

A hot melt dispensing system includes a melter, a feed system, a dispenser and a filter. The feed system delivers hot melt pellets to the melter. The dispenser dispenses liquefied hot melt adhesive from the melter. The filter is connected to the feed system and prevents contaminants from passing through the feed system. In one embodiment, the filter comprises a screen filter positioned near a bottom of a pellet hopper. In another embodiment, the filter comprises a series of baffles positioned along the pellet hopper. In yet another embodiment, the filter comprises an electro-static filter coupled to a feed hose.

### BACKGROUND

The present disclosure relates generally to systems for dispensing hot melt adhesive. More particularly, the present disclosure relates to feed systems for hot melt systems.

Hot melt dispensing systems are typically used in manufacturing assembly lines to automatically disperse an adhesive used in the construction of packaging materials such as boxes, cartons and the like. Hot melt dispensing systems conventionally comprise a material tank, heating elements, a pump and a dispenser. Solid polymer pellets are melted in the material tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure.

Systems for dispensing hot melt adhesive utilize a container, such as a hopper, to hold solid polymer pellets for distribution to the material tank for melting. Under certain conditions, the solid polymer pellets can become fouled with contaminants. For example, large foreign objects not intended to be in the hopper, such as tools, may accidentally fall into the hopper. Furthermore, dust, dirt and polymer particles can collect in the hopper, potentially causing blockages.

### SUMMARY

According to the present invention, a hot melt dispensing system includes a melter, a feed system, a dispenser and a filter. The feed system delivers hot melt pellets to the melter. The dispenser dispenses liquefied hot melt adhesive from the melter. The filter is connected to the feed system and prevents contaminants from passing through the feed system. In one embodiment, the filter comprises a screen filter positioned near a bottom of a pellet hopper. In another embodiment, the filter comprises a series of baffles positioned along the pellet hopper. In yet another embodiment, the filter comprises an electro-static filter coupled to a feed hose.

### BRIEF DESCRIPTION OF THE DRAWINGS

FIG. 1 is a schematic view of a system for dispensing hot melt adhesive that includes a feed system with a plurality of particulate filters.

FIG. 2 is a cross-sectional view of a feed system comprising a hopper including a baffle filter and a screen filter.

FIG. 3 is a cross-sectional view of a feed system including a feeder, a wand, an electro-static filter and a hose.

### DETAILED DESCRIPTION

FIG. 1 is a schematic view of one embodiment of system 10, which is a system for dispensing hot melt adhesive. System 10 includes cold section 12, hot section 14, air source 16, air control valve 17, and controller 18. In the embodiment shown in FIG. 1, cold section 12 includes container 20 and feed system 22, which includes feeder 24, feed hose 26, inlet 28 and wand 29. In the embodiment shown in FIG. 1, hot section 14 includes melt system 30, pump 32, and dispenser 34. Air source 16 is a source of compressed air supplied to components of system 10 in both cold section 12 and hot section 14. Air control valve 17 is connected to air source 16 via air hose 35A, and selectively controls air flow from air source 16 through air hose 35B to feeder 24, and through air hose 35C to motor 36 of pump 32. Air hose 35D connects air source 16 to dispenser 34, bypassing air control valve 17. Controller 18 is connected in communication with various components of system 10, such as air control valve 17, melt system 30, pump 32, and/or dispenser 34, for controlling operation of system 10.

Components of cold section 12 can be operated at room temperature, without being heated. Container 20 can be a hopper for containing a quantity of solid adhesive pellets for use by system 10. Suitable adhesives can include, for example, a thermoplastic polymer glue such as ethylene vinyl acetate (EVA) or metallocene. Feed system 22 connects container 20 to hot section 14 for delivering the solid adhesive pellets from container 20 to hot section 14. Feeder 24 is mounted to wand 29 and includes inlet 28. Wand 29 and feeder 24 are inserted into container 20. Wand 29 comprises a rigid tube that extends from container 20 and connects to feed hose 26. Wand 29 and feed hose 26 form a feed line having a passage sized with a diameter substantially larger than that of the solid adhesive pellets to allow the solid adhesive pellets to flow freely through feed hose 26. Feed hose 26 connects feeder 24 to hot section 14.

In one embodiment, compressed air from air source 16 and air control valve 17 is delivered to feeder 24 to create a vacuum, inducing flow of solid adhesive pellets into inlet 28 of feeder 24 and then through wand 29 and feed hose 26 to hot section 14. In another embodiment, feeder 24 additionally includes an integrated shaker that is actuated with compressed air from air control valve 17 in route to creating the vacuum. The agitation facilitates the settling of the solid adhesive pellets in container 20 as well as breaks apart bunched pellets before they reach feeder 24. After use in the shaker, the compressed air is exhausted to operate a Venturi vacuum to produce suction which induces the flow of the solid adhesive pellets through inlet 28, wand 29, and then through feed hose 26 to hot section 14.

Solid adhesive pellets are delivered from feed hose 26 to melt system 30. Melt system 30 can include a container (not shown) and resistive heating elements (not shown) for melting the solid adhesive pellets to form a hot melt adhesive in liquid form. Melt system 30 can be sized to have a relatively small adhesive volume, for example about 0.5 liters, and configured to melt solid adhesive pellets in a relatively short period of time. Pump 32 is driven by motor 36 to pump hot melt adhesive from melt system 30, through supply hose 38, to dispenser 34. Motor 36 can be an air motor driven by pulses of compressed air from air source 16 and air control valve 17. Pump 32 can be a linear displacement pump driven by motor 36. In the illustrated embodiment, dispenser 34 includes manifold 40 and dispensing module 42. Hot melt adhesive from pump 32 is received in manifold 40 and dispensed via module 42. Dispenser 34 can selectively discharge hot melt adhesive whereby the hot melt adhesive is sprayed out outlet 44 of dispensing module 42 onto an object, such as a package, a case, or another object benefiting from hot melt adhesive dispensed by system 10. Dispensing module 42 can be one of multiple modules that are part of dispenser 34. In an alternative embodiment, dispenser 34 can have a different configuration, such as a handheld gun-type dispenser. Some or all of the components in hot section 14, including melt system 30, pump 32, supply hose 38, and dispenser 34, can be heated to keep the hot melt adhesive in a liquid state throughout hot section 14 during the dispensing process.

System 10 can be part of an industrial process, for example, for packaging and sealing cardboard packages and/or cases of packages. In alternative embodiments, system 10 can be modified as necessary for a particular industrial process application. For example, in one embodiment (not shown), pump 32 can be separated from melt system 30 and instead attached to dispenser 34. Supply hose 38 can then connect melt system 30 to pump 32.

In the present invention, feed system 22 includes various filters used to remove solid matter contaminants from the solid adhesive pellets. Specifically, container 20 includes screen filter 46 and baffle filters 48A, 48B and 48C, while wand 29 includes electro-static filter 50. Filters 46, 48A-48C and 50 can be used individually, together or in any combination of the three. Baffle filters 48A-48C filter out larger sized particles before reaching feeder 24. Screen filter 46 allows small granular contaminants to collect at the bottom of container 40. Electro-static filter 50 removes fine particles from wand 29 before passing into feed hose 26 and melt system 30.

FIG. 2 is a cross-sectional view of feed system 22 comprising container 20 including screen filter 46, baffle filters 48A-48C, shaker 49 and electro-static filter 50. Container 20 comprises a storage vessel, such as a hopper, cylindrical drum or rectilinear box, having bottom wall 20A and sidewall portions 20B and 20C. Screen filter 46 extends from first sidewall portion 20B to second sidewall portion 20C in close proximity to bottom wall 20A. Baffle 48A extends from first sidewall portion 20A towards second sidewall portion 20B to leave gap 52A. Baffle 48B extends from second sidewall portion 20B towards first sidewall portion 20A to leave gap 52B. Baffle 48C extends from first sidewall portion 20A towards second sidewall portion 20B to leave gap 52C. Baffles 48A-48C are angled inward, or declined, toward bottom wall 20A. Baffles 48A-48C include openings 54A-54C, respectively, to accept wand 29, feed hose 26 and air hose 35B. However, in another embodiment, wand 29, feed hose 26 and air hose 35B may be inserted into container 20 through sidewall 20C, for example, to be positioned between baffle 48C and screen filter 46.

Feeder 24 is disposed within container 20 and rests upon screen filter 46. Wand 29 extends towards an upper opening formed between sidewall portions 20B and 20C, and connects to feed hose 26. Air hose 35B extends from feeder 24, along wand 29 and out of container 20. Feed hose 26 and air hose 35B connect to melt system 30 and air valve 17, respectively, as shown in FIG. 1.

Baffle 48A is positioned near the upper opening of container 20 and forms a surface upon which solid adhesive pellets are dumped to fill container 20. The solid pellets slide along baffle 48A toward sidewall portion 20B and gap 52A due to the declined orientation of baffle 48A. Gap 52A is sized to prevent large items from sliding off of baffle 48A, reaching baffle 48B and ultimately reaching feeder 24. For example, gap 52A can be sized to catch large sized objects such as tools or the like that may accidentally become dropped into container 20.

In another embodiment, baffle 48A extends all the way to sidewall portion 20B such that gap 52A is eliminated. In such an embodiment, baffle 48A includes perforations that are larger than the size of the solid pellets used with system 10 (FIG. 1). The perforations allow the solid pellets to pass through, while mechanically blocking larger sized objects. Thus, the perforations provide a first level of filtering to catch large sized matter from falling to feeder 24.

Baffle 48B is positioned at an intermediate position within container 20 between baffle 48A and baffle 48C. Baffle 48B forms a surface upon which solid adhesive pellets from baffle 48A are dropped onto at gap 52A. The solid pellets slide along baffle 48B toward sidewall portion 20C and gap 52B due to the declined orientation of baffle 48B. Gap 52B is sized to prevent intermediate sized items from sliding off of baffle 48B, reaching baffle 48C and ultimately reaching feeder 24. For example, gap 52B can be sized to catch intermediate sized objects such as coins or the like that may accidentally become dropped into container 20.

In another embodiment, baffle 48B extends all the way to sidewall portion 20C such that gap 52B is eliminated. In such and embodiment, baffle 48B includes perforations that are larger than the size of the solid pellets used with system 10 (FIG. 1). The perforations allow the solid pellets to pass through, while mechanically blocking larger sized objects. Thus, the perforations provide a second level of filtering to catch intermediate sized matter from falling to feeder 24. Gap 52B or any perforations within baffle 48B are sized smaller than gap 52A or any perforations within baffle 48A, respectively, to provide a progressive series of filtration.

Baffle 48C is positioned at a lower position within container 20 between baffle 48B and screen filter 46. Baffle 48C forms a surface upon which solid adhesive pellets from baffle 48B are dropped onto at gap 52B. The solid pellets slide along baffle 48C toward sidewall portion 20B and gap 52C due to the declined orientation of baffle 48C. Gap 52C is sized to prevent small sized items from sliding off of baffle 48C, reaching screen filter 46 and ultimately reaching feeder 24. For example, gap 52C can be sized to catch small sized objects such as pebbles or the like that may accidentally become dropped into container 20.

In another embodiment, baffle 48C extends all the way to sidewall portion 20B such that gap 52C is eliminated. In such an embodiment, baffle 48C includes perforations that are larger than the size of the solid pellets used with system 10 (FIG. 1). The perforations allow the solid pellets to pass through, while mechanically blocking larger sized objects. Thus, the perforations provide a third level of filtering to catch small sized particles from falling to feeder 24. Gap 52C or any perforations within baffle 48C are sized smaller than gap 52B or any perforations within baffle 48B, respectively, to provide a progressive series of filtration. For example, baffles 48A-48C could be provided with perforations having diameters of 0.5 inch (˜1.27 cm), 0.25 inch (˜0.64 cm) and 0.1875 inch (˜0.48 cm).

Baffles 48A-48C may include various combinations of gaps and perforations. For example, gaps 52A and 52B may be used in baffles 48A and 48C, respectively, while providing baffle 48B with perforations. Although described with reference to three baffles, feed system 22 may incorporate baffle-type filters described herein having fewer or more baffle layers.

Contaminants within solid adhesive pellets are caught by baffles 48A-48C as gravity moves pellets through container 20. In the described embodiment, any contaminants caught by baffles 48A-48C are manually removed, such as by reaching into container 20 at the upper opening. Alternatively, access ports (not shown) may be provided proximate the declined end of each baffle, for example.

After passing through gaps 52A-52C and/or any perforations within baffles 48A-48C, solid adhesive pellets fall onto screen filter 46. Screen filter 46 defines a mesh size that filters fine sized particles such as dust and dirt. Screen filter 46 allows the contaminants to drop to bottom wall 20A away from inlet 28 of feeder 24 via action of gravity, while the solid adhesive pellets remain supported on screen filter 46. In one embodiment, screen filter 46 is positioned approximately 1 inch (˜2.54 cm) above bottom wall 20A. At inlet 28, feeder 24 ingests solid adhesive pellets that accumulate on filter 46 for transport through wand 29 and feed tube 26 to melt system 30 (FIG. 1). Dust and dirt that accumulates on bottom wall 20A is removed through drain port 55. In one embodiment, drain port 55 is coupled to vacuum hose 55A, which suctions dust and dirt from container 20. Vacuum hose 55A may be powered with compressed air from air source 16 (FIG. 1).

Shaker 49 is positioned on container 20 to facilitate flow of solid adhesive pellets through feed system 22. Shaker 49 causes vibration of container 20 and, therefore, baffles 48A-48C and filter 46. The vibration prevents solid adhesive pellets from clumping at choke points through the feed circuit formed by gaps 52A-52C and opening 28. The vibration also facilitates dropping of dust and dirt through the small openings of screen 46. Shaker 49 may be powered with compressed air from air source 16 (FIG. 1). In various embodiments, shaker 49 can be driven by hydraulic, electrical, mechanical or other means. In one embodiment, shaker 49 comprises a pneumatic vibrator such as model # BBS-130 manufactured by VIBCO of Wyoming, R.I. In another embodiment, shaker 49 can comprise an ultrasonic shaker.

FIG. 3 is a cross-sectional view of wand 29 positioned between feeder 24 and electro-static filter 50. Feeder 24 comprises housing 56, defined by sections 56A and 56B, raceway 58, shaker ball 60, cavity 61, fastener 63 and insert 64. Electro-static filter 50 comprises housing 66, tube sections 68A and 68B and power supply 70.

Compressed air from air hose 35B (FIG. 1) travels into housing 56 at an inlet (not shown), passes through raceway 58, and through exit (not shown) located in cavity 61. Raceway 58 is defined by sections 56A and 56B of housing 56, which are held together by fasteners 63. Air travelling through raceway 58 causes ball 60 to orbit insert 64 as it rolls along the circumference of raceway 58. The weight imbalance caused by movement of ball 60 induces vibration of housing 56. Vibration of housing 56 prevents solid adhesive pellets from clumping or otherwise forming an obstruction in inlet 28.

From cavity 61, the compressed air passes into passage 72, which defines a Venturi vacuum forming a flow path having a converging-diverging configuration, as is known in the art. The Venturi effect produced by the flow of compressed air through passage 72 produces a pressure differential between inlet 28 and outlet 74 that imparts an acceleration to hot melt pellets at inlet 28. The increased velocity that results from the Venturi effect allows feeder 24 to discharge the adhesive pellets effectively along the length of wand 29 and feed hose 26 (FIG. 1).

In the described embodiment, feeder 24 comprises a combined Venturi tube and shaker that utilizes a single flow of compressed air to accomplish both tasks. Such a combined feeder is described in U.S. patent application Ser. No. 13/705,858 entitled “VACUUM AND SHAKER FOR A HOT MELT SYSTEM,” which is assigned to Graco Minnesota Inc. and incorporated herein by this reference.

Standoff 76 extends from second housing potion 56B to contact container 20 (FIG. 1) to provide space between inlet 28 and screen filter 46. This space allows solid adhesive pellets to enter into inlet 28. Solid adhesive pellets enter feeder 24 at inlet 28, pass through insert 64 and passage 72 and flow into wand 29. Solid adhesive pellets often contain fine particles that can cause fowling within hot melt system 10 (FIG. 1). The particles typically comprise dust or dirt, or small particles of the solid hot melt material. Fine particles of the hot melt material can prematurely melt within melt system 30 (FIG. 1) and cause malfunctioning of components of melt system 30, such as level indicator windows, baffles or level sensors. Electro-static filter 50 inhibits fine particles of contaminants from passing through feed system 22 (FIG. 2).

Electro-static filter 50 removes particulate matter entrained within solid adhesive pellets as the mixture travels through tube sections 68A and 68B. Tube sections 68A and 68B are mounted within housing 66, which forms a portion of wand 29 having an enlarged diameter to accommodate tube sections 68A and 68B. Tube sections 68A and 68B may be mounted within housing 66 in any suitable manner. Housing 66 may be coupled to wand 29 by any suitable method or may be integrally formed as part of wand 29.

Tube sections 68A and 68B form two parallel plates that are separated from each other to form a gap, which comprises the flow space within wand 29. Thus, each section comprises an approximately one-hundred-eighty degree arc that is concentric with wand 29. The arc segments may be insulated from each other to facilitate formation of an electro-static field. Power source 70 is connected to each of tube sections 68A and 68B. Power source 70, which may be a component of controller 18 (FIG. 1), provides a voltage difference between tube sections 68A and 68B that produces an electro-static field. In the disclosed embodiment, tube section 68A is positively charged, and tube section 68B is negatively charged via terminal t₁. Each of the charged tube section produces ions of like charge within the flow path through wand 29. The charged ions pull positively and negatively charged contamination particles traveling through wand 29 toward the tube section of like polarity. The charged ions hold the contamination particles in place while solid adhesive pellets continue to flow through wand 29. Contamination particles can be removed from electro-static filter periodically at regular maintenance intervals. Thus, housing 66 includes access openings (not shown) in order to remove or replace tube sections 68A and 68B, or remove or replace collection layers attached to tube sections 68A and 68B. FIG. 3 schematically illustrates the principles of operation of electro-static filters, which are known in the art of filtration systems. The specific location, length and size of electro-static filter 50 can be selected based on design needs.

The present disclosure describes various filtration systems that can be used with hot melt adhesive systems. Container 20, feeder 24, feed tube 26 and wand 29 define a feed circuit through feed system 22 between the upper opening of hopper 22 and the discharge end of feed tube 26 coupled to melt system 30 (FIG. 1). Baffles 48A-48C and screen filter 46 comprise mechanical blockage filters positioned in the feed circuit that remove solid particulate matter via operation of gravity. Electro-static filter 50 comprises an electrically operated filter positioned in the feed circuit that removes solid particulate matter via operation of ionization. Although described with reference to hot melt system 10 having baffles 48A-48C, screen filter 46 and electro-static filter 50, each of these filtration systems may be used exclusively or in combination with any other filtration system. Removal of foreign objects from hot melt adhesive system 10 eliminates shutdown time to perform maintenance required to move objects that pass into the system. Additionally, removal of hot melt adhesive dust from feed system 22 prevents premature liquefaction of hot melt adhesive that can cause fouling of melt system 30.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A hot melt dispensing system comprising:
a melter;
a feed system for delivering hot melt pellets to the melter;
a dispenser for dispensing liquefied hot melt adhesive from the melter; and
a filter connected to the feed system for preventing contaminants from passing through the feed system.

2. The hot melt dispensing system of claim 1, wherein the feed system comprises:
a hopper for storing hot melt pellets;
a feed line extending from the hopper to the melter; and
a feeder connected to the feed line to move hot melt pellets from the hopper to the melter.

3. The hot melt dispensing system of claim 2, wherein the filter comprises:
a statically charged filter element.

4. The hot melt dispensing system of claim 3, wherein the statically charged filter element is coupled to the feed line.

5. The hot melt dispensing system of claim 3, wherein the feeder comprises:
a Venturi vacuum for drawing hot melt pellets through the feed line.

6. The hot melt dispensing system of claim 5, wherein the statically charged filter element comprises:
a filter tube positioned in the feed line between the Venturi vacuum and the melter; and
an electrical charging element for producing a charge on the filter tube.

7. The hot melt dispensing system of claim 2, wherein the filter comprises:
a screen positioned within the hopper.

8. The hot melt dispensing system of claim 6, wherein:
the hopper defines a bottom surface; and
the screen extends from the hopper between the bottom surface and the feeder.

9. The hot melt dispensing system of claim 2, wherein the filter comprises:
a baffle positioned within the hopper.

10. The hot melt dispensing system of claim 9, wherein:
the hopper defines side wall portions and a bottom surface; and
the baffle comprises a plurality of shelves, each shelf extending from a first side wall portion at an angle toward the bottom surface and a second side wall portion.

11. The hot melt dispensing system of claim 10, wherein each of the plurality of shelves is spaced from a second side wall portion to define a gap, the plurality of shelves defining a series of progressively smaller gaps.

12. The hot melt dispensing system of claim 10 wherein each of the plurality of shelves is perforated, the plurality of shelves defining a series of progressively smaller perforations.

13. A feed system for a hot melt system, the feed system comprising:
a hopper for storing hot melt pellets;
a delivery line extending from the hopper;
a feeder coupled to the delivery line within the hopper to move hot melt pellets from the hopper to a hot melt dispensing system; and
a filter;
wherein the hopper, the delivery line and the feeder define a feed circuit and the filter is disposed in the feed circuit to remove solid contaminants from the feed system.

14. The hot melt dispensing system of claim 13, wherein:
the filter comprises a screen disposed proximate a bottom of the hopper;
the feeder is disposed above the screen; and
the screen filters contaminants to the bottom of the hopper.

15. The hot melt dispensing system of claim 13, wherein:
the filter comprises an electro-static filtering element disposed within the feed circuit.

16. The hot melt dispensing system of claim 13, wherein:
the filter comprises a series of baffles spaced within in the hopper;
the feeder is disposed between the series of baffles and the bottom of the hopper; and
the series of baffles filters progressively smaller contaminants from the feed circuit.

17. The hot melt dispensing system of claim 16 wherein the series of baffles form a series of gaps between the baffles and the hopper.

18. The hot melt dispensing system of claim 16 wherein each baffle in the series of baffles include perforations.

19. A filtration system for a hot melt adhesive system, the filtration system comprising:
a hopper for storing solid pellets, the hopper comprising:
a lower bottom;
a sidewall; and
an upper opening;
a feed tube extending from the hopper at a first end to outside the hopper at a second end;
a vacuum feeder coupled to the first end of the feed tube to draw solid pellets from the hopper through the feed tube; and
a filter positioned between the upper opening and the second end of the feed tube to remove solid contaminants from the solid pellets.

20. The filtration system of claim 19 wherein the filter comprises a gravity filter positioned in the hopper below the upper opening to prevent solid contaminants from reaching the vacuum feeder.

21. The filtration system of claim 19 wherein the filter comprises an electro-static filter positioned in the feed tube between the vacuum feeder and the second end to prevent solid contaminants from leaving the feed tube.
